(19) United States
(12) Patent Application Publication
(10) Pub. No.: US 2023/0342889 A1
(43) Pub. Date: Oct. 26, 2023

(54) FREQUENCY DOMAIN EDGE ENHANCEMENT OF IMAGE CAPTURE

(71) Applicant: QUALCOMM Incorporated, San Diego, CA (US)

(72) Inventors: Wen-Chun FENG, New Taipei City (TW); Hsuan-Ying LIAO, Hsinchu City (TW); Hsin Yueh CHANG, Zhubei City (TW); Yu-Ren LAI, Nantou County (TW); Shizhong LIU, San Diego, CA (US); Weiliang LIU, San Diego, CA (US)

(21) Appl. No.: 17/729,561

(22) Filed: Apr. 26, 2022

(51) Int. Cl. G06T 5/00; G06T 5/50; G06T 7/33; G06T 3/00

(52) U.S. Cl. CPC G06T 5/003; G06T 5/50; G06T 7/337; G06T 3/0093; G06T 2207/20021; G06T 2207/20208; G06T 2207/20192; G06T 2207/20221

(57) ABSTRACT

Systems, methods, and non-transitory media are provided for frequency domain edge enhancement of multi-exposure high dynamic range (HDR) images. An example method can include determining an alignment between an HDR frame and a frame having an exposure time above a threshold; adjusting the frame based on the alignment; determining a gradient estimation map representing differences between image blocks in the HDR frame and image blocks in the frame; and generating, based on the gradient estimation map, a merged frame that includes a combination of at least some image data from the HDR frame and at least some image data from the frame.

### TECHNICAL FIELD

The present disclosure generally relates to image capture (e.g., capturing one or more photographs or videos). For example, aspects of the present disclosure relate to frequency of domain edge enhancement of multi-exposure high dynamic range images.

### BACKGROUND

Electronic devices are increasingly equipped with camera hardware to capture images and/or videos for consumption. For example, a computing device can include a camera (e.g., a mobile device such as a mobile telephone or smartphone including one or more cameras) to allow the computing device to capture a video or image of a scene, a person, an object, etc. The image or video can be captured and processed by the computing device (e.g., a mobile device, an IP camera, extended reality device, connected device, etc.) and stored or output for consumption (e.g., displayed on the device and/or another device). In some cases, the image or video can be further processed for effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

### BRIEF SUMMARY

Systems and techniques are described herein for frequency domain edge enhancement of multi-exposure high dynamic range images. According to at least one example, a method is provided for processing image data. The method can include: determining an alignment between a high dynamic range (HDR) frame and a frame having an exposure time above a threshold; adjusting the frame based on the alignment; determining a gradient estimation map representing differences between image blocks in the HDR frame and image blocks in the frame; and generating, based on the gradient estimation map, a merged frame that includes a combination of at least some image data from the HDR frame and at least some image data from the frame.

In another example, an apparatus for processing image data is provided that includes at least one memory and at least one processor (e.g., configured in circuitry) coupled to the at least one memory. The at least one processor is configured to: determine an alignment between a high dynamic range (HDR) frame and a frame having an exposure time above a threshold; adjust the frame based on the alignment; determine a gradient estimation map representing differences between image blocks in the HDR frame and image blocks in the frame; and generate, based on the gradient estimation map, a merged frame that includes a combination of at least some image data from the HDR frame and at least some image data from the frame.

In another example, a non-transitory computer-readable medium is provided that has stored thereon instructions that, when executed by one or more processors, cause the one or more processors to: determine an alignment between a high dynamic range (HDR) frame and a frame having an exposure time above a threshold; adjust the frame based on the alignment; determine a gradient estimation map representing differences between image blocks in the HDR frame and image blocks in the frame; and generate, based on the gradient estimation map, a merged frame that includes a combination of at least some image data from the HDR frame and at least some image data from the frame.

In another example, an apparatus for processing image data is provided. The apparatus includes: means for determining an alignment between a high dynamic range (HDR) frame and a frame having an exposure time above a threshold; means for adjusting the frame based on the alignment; means for determining a gradient estimation map representing differences between image blocks in the HDR frame and image blocks in the frame; and means for generating, based on the gradient estimation map, a merged frame that includes a combination of at least some image data from the HDR frame and at least some image data from the frame.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a mobile device (e.g., a mobile telephone or so-called “smart phone” or other mobile device), a wearable device, a personal computer, a laptop computer, a tablet computer, a server computer, a robotics device or system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an electronic device used perform frequency domain edge enhancements of image frames, in accordance with some examples of the present disclosure;

FIG. 2 is a diagram illustrating an example process for performing frequency domain edge enhancements of image frames, in accordance with some examples of the present disclosure;

FIG. 3 is a diagram illustrating an example process for image alignment, in accordance with some examples of the present disclosure;

FIG. 4 is a diagram illustrating an example gradient estimation performed prior to an image fusion, in accordance with some examples of the present disclosure;

FIG. 5 is a diagram illustrating an example image fusion for merging an HDR frame and a long exposure frame, in accordance with some examples of the present disclosure;

FIG. 6 is a flowchart illustrating an example process for frequency domain edge enhancement of multi-exposure high dynamic range (HDR) images, in accordance with some examples of the present disclosure; and

FIG. 7 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) can implement cameras to capture images or video frames of a scene, a person(s), an animal(s), and/or any object(s). A camera can refer to a device that receives light and captures image frames, such as still images or video frames, using an image sensor. The terms “image,” “image frame,” and “frame” are used interchangeably herein. A camera system can include processors (e.g., an image signal processor (ISP), etc.) that can receive one or more images and process the one or more images. For example, a raw image captured by a camera sensor can be processed by an ISP to generate a final image. Processing by the ISP can be performed by filters or processing blocks applied to the captured image, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

In some cases, a camera device of an electronic device can be configured to perform multi-exposure high dynamic range (HDR). Multi-exposure HDR is a technique that allows a camera device to capture HDR frames and combine several different exposures of a same scene. In some cases, to generate an HDR image, a short exposure or long exposure image can be used as an anchor (e.g., a reference) in a spatial domain. However, using a short exposure image or a long exposure image as an anchor in the spatial domain to generate an HDR image can have certain tradeoffs. For example, using a short exposure image as an anchor can result in more noise in the image (e.g., than using a long exposure image), but results in limited or no ghosting issues. On the other hand, using a long exposure image as an anchor is prone to ghosting, but may result in better image quality than using a short exposure image as an anchor.

Systems, apparatuses, methods (also referred to as processes), and computer-readable media (collectively referred to herein as “systems and techniques”) are described herein for frequency domain edge enhancement of multi-exposure HDR images. In some examples, the systems and techniques described herein can provide a computational photography pipeline that aligns and merges a long exposure frame to an HDR frame to achieve noise reduction and texture enhancement in the frequency domain. The merging the long exposure frame and the HDR frame can result in decreased image noise, increased texture, limited or no ghosting, etc.

Various aspects of the application will be described with respect to the figures.

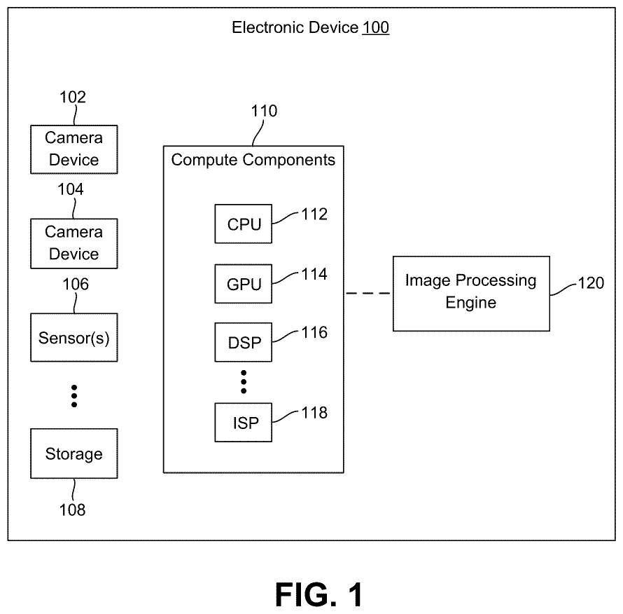

FIG. 1 is a diagram illustrating an example of an electronic device 100 used to capture image data. In some examples, the electronic device 100 can include a camera device and can be configured to perform frequency domain edge enhancement of multi-exposure HDR images, as further described herein. In some aspects, the electronic device 100 can be configured to provide one or more functionalities such as, for example, imaging functionalities, image data segmentation functionalities, detection functionalities (e.g., object detection, pose detection, face detection, shape detection, scene detection, etc.), image processing functionalities, extended reality (XR) functionalities (e.g., localization/tracking, detection, classification, mapping, content rendering, etc.), device management and/or control functionalities, gaming functionalities, computer vision, robotic functions, automation, and/or any other computing functionalities.

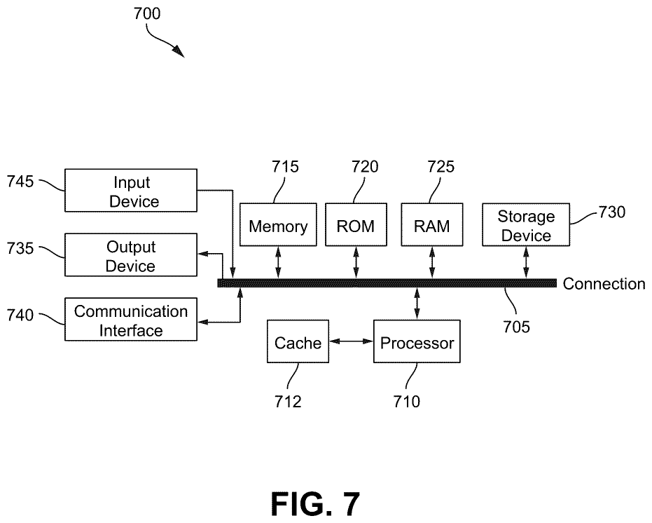

In the illustrative example shown in FIG. 1, the electronic device 100 can include one or more camera devices (e.g., two camera devices, three camera devices, four camera devices, or more camera devices). In one example as shown in FIG. 1, the electronic device 100 may include camera device 102 and camera device 104, but may include fewer or more camera devices in other examples. As further illustrated in FIG. 1, the electronic device 100 can include one or more sensors 106, such as an ultrasonic sensor, an inertial measurement unit, a depth sensor using any suitable technology for determining depth (e.g., based on time-of-flight (ToF), structured light, or other depth sensing technique or system), a touch sensor, a microphone, any combination thereof, and/or other sensors. The electronic device 100 can further include a storage 108 and one or more compute components 110. In some cases, the electronic device 100 can optionally include one or more other/additional sensors such as, for example and without limitation, a pressure sensor (e.g., a barometric air pressure sensor and/or any other pressure sensor), a gyroscope, an accelerometer, a magnetometer, and/or any other sensor. In some examples, the electronic device 100 can include additional components such as, for example, a light-emitting diode (LED) device, a cache, a communications interface, a display, a memory device, etc. An example architecture and example hardware components that can be implemented by the electronic device 100 are further described below with respect to FIG. 7.

The electronic device 100 can be part of, or implemented by, a single computing device or multiple computing devices. In some examples, the electronic device 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a gaming console, an XR device such as an HMD, an IoT (Internet-of-Things) device, a smart wearable device, or any other suitable electronic device(s).

In some implementations, the camera device 102, the camera device 104, the one or more sensors 106, the storage 108, and/or the one or more compute components 110 can be part of the same computing device. For example, in some cases, the one or more camera devices of the electronic device (e.g., the camera device 102, the camera device 104, and/or other camera device(s)), the one or more sensors 106, the storage 108, and/or the one or more compute components 110 can be integrated with or into a camera system, a smartphone, a laptop, a tablet computer, a smart wearable device, an XR device such as an HMD, an IoT device, a gaming system, and/or any other computing device. In other implementations, the camera device 102, the camera device 104, the one or more sensors 106, the storage 108, and/or the one or more compute components 110 can be part of, or implemented by, two or more separate computing devices.

The one or more compute components 110 of the electronic device 100 can include, for example and without limitation, a central processing unit (CPU) 112, a graphics processing unit (GPU) 114, a digital signal processor (DSP) 116, and/or an image signal processor (ISP) 118. In some examples, the electronic device 100 can include other processors or processing devices such as, for example, a computer vision (CV) processor, a neural network processor (NNP), an application-specific integrated circuit (ASIC), a field-programmable gate array (FPGA), etc. The electronic device 100 can use the one or more compute components 110 to perform various computing operations such as, for example, HDR and image processing functionalities as described herein, extended reality operations (e.g., tracking, localization, object detection, classification, pose estimation, mapping, content anchoring, content rendering, etc.), detection (e.g., face detection, object detection, scene detection, human detection, etc.), image segmentation, device control operations, image/video processing, graphics rendering, machine learning, data processing, modeling, calculations, computer vision, and/or any other operations.

In some cases, the one or more compute components 110 can include other electronic circuits or hardware, computer software, firmware, or any combination thereof, to perform any of the various operations described herein. In some examples, the one or more compute components 110 can include more or less compute components than those shown in FIG. 1. Moreover, the CPU 112, the GPU 114, the DSP 116, and the ISP 118 are merely illustrative examples of compute components provided for explanation purposes.

The one or more camera devices of the electronic device 100 (e.g., the camera device 102, the camera device 104, and/or other camera device(s)) can include any image and/or video sensor and/or image/video capture device, such as a digital camera sensor, a video camera sensor, a smartphone camera sensor, an image/video capture device on an electronic apparatus such as a television or computer, a camera, etc. In some aspects, in cases where multiple camera devices are included, the camera devices may include different lenses (e.g., different focal length, different apertures or variable aperture, etc.). In some cases, the one or more camera devices of the electronic device 100 (e.g., the camera device 102, the camera device 104, and/or other camera device(s)) can be part of a camera system or computing device such as a digital camera, a video camera, an IP camera, a smartphone, a smart television, a game system, etc. Moreover, in some cases, the one or more camera devices of the electronic device 100 (e.g., the camera device 102, the camera device 104, and/or other camera device(s)) can include multiple image sensors, such as rear and front sensor devices, and in some aspects can be part of a dual-camera or other multi-camera assembly (e.g., including two camera, three cameras, four cameras, or other number of cameras). In some examples, the one or more camera devices of the electronic device 100 (e.g., the camera device 102, the camera device 104, and/or other camera device(s)) can be part of a camera. The camera can be configured to implement a frequency domain edge enhancement of images, as further described herein.

In some examples, the camera device 102 and the camera device 104 can capture image data and generate frames based on the image data and/or provide the image data or frames to the one or more compute components 110 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

The storage 108 can include any storage device(s) for storing data such as, for example and without limitation, image data, posture date, scene data, user data, preferences, etc. The storage 108 can store data from any of the components of the electronic device 100. For example, the storage 108 can store data or measurements from any of the camera devices 102 and 104, the one or more sensors 106, the compute components 110 (e.g., processing parameters, outputs, video, images, segmentation maps/masks, depth maps, filtering results, calculation results, detection results, etc.), the image processing engine 120, and/or any other components. In some examples, the storage 108 can include a buffer for storing data (e.g., image data, posture data, etc.) for processing by the compute components 110.

The one or more compute components 110 can perform image/video processing, edge enhancement functionalities, HDR functionalities, machine learning, XR processing, device management/control, detection (e.g., object detection, face detection, scene detection, human detection, etc.) and/or other operations as described herein using data from the camera device 102, the camera device 104, the one or more sensors 106, the storage 108, and/or any other sensors and/or components. In some examples, the one or more compute components 110 can implement one or more software engines and/or algorithms such as, for example, an image processing engine 120 or algorithm as described herein. In some cases, the one or more compute components 110 can implement one or more other or additional components and/or algorithms such as a machine learning model(s), a computer vision algorithm(s), a neural network(s), and/or any other algorithm and/or component.

The image processing engine 120 can implement one or more algorithms and/or machine learning models configured to implement frequency domain edge enhancement using HDR images, described herein. In some examples, the image processing engine 120 can be configured to align and merge a long exposure frame and an HDR frame to achieve noise reduction and texture enhancement in the frequency domain.

The components shown in FIG. 1 with respect to the electronic device 100 are illustrative examples provided for explanation purposes. In other examples, the electronic device 100 can include more or less components than those shown in FIG. 1. While the electronic device 100 is shown to include certain components, one of ordinary skill will appreciate that the electronic device 100 can include more or fewer components than those shown in FIG. 1. For example, the electronic device 100 can include, in some instances, one or more memory devices (e.g., RAM, ROM, cache, and/or the like), one or more networking interfaces (e.g., wired and/or wireless communications interfaces and the like), one or more display devices, caches, storage devices, and/or other hardware or processing devices that are not shown in FIG. 1. An illustrative example of a computing device and/or hardware components that can be implemented with the electronic device 100 are described below with respect to FIG. 7.

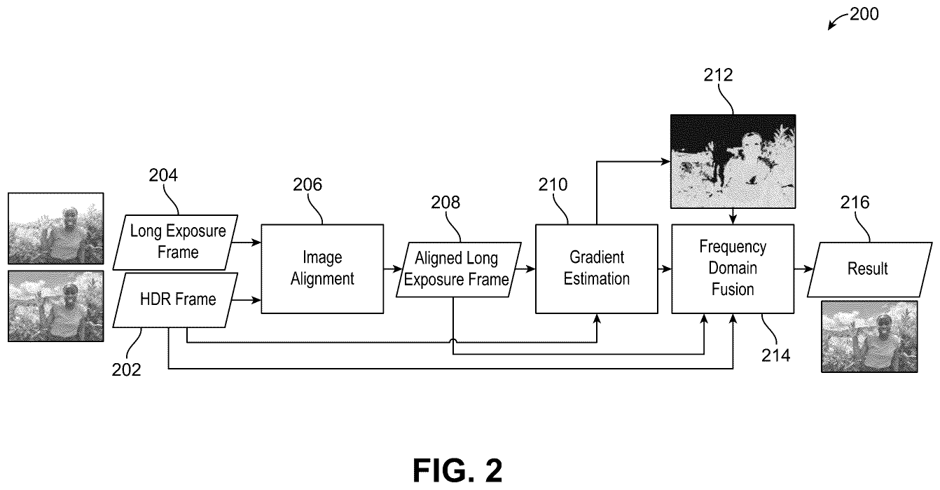

FIG. 2 is a diagram illustrating an example process 200 for performing frequency domain edge enhancements of image frames, according to some examples of the present disclosure. In this example, the process 200 obtains an HDR frame 202 and a long exposure frame 204 and performs image alignment 206 to align the HDR frame 202 and a long exposure frame 204 (e.g., to align features and/or points between the HDR frame 202 and a long exposure frame 204). For instance, the process 200 may align the long exposure frame 204 to the HDR frame 202, or may align the HDR frame 202 to the long exposure frame 204.

In some examples, the electronic device 100 can perform feature point detection on the HDR frame 202 and a long exposure frame 204 to detect feature points on the HDR frame 202 and a long exposure frame 204. The electronic device 100 can also perform global and local motion estimation on the HDR frame 202 and a long exposure frame 204 to determine global motion of the HDR frame 202 and a long exposure frame 204 and local motion (e.g., motion associated with pixels, pixel regions, image blocks, and/or frame regions associated with detected feature points). The electronic device can use the feature point detection results from the feature point detection on the HDR frame 202 and a long exposure frame 204 and the global and local motion estimation results for the HDR frame 202 and a long exposure frame 204 to align the HDR frame 202 and a long exposure frame 204 (e.g., by aligning the long exposure frame 204 to the HDR frame 202 or by aligning the HDR frame 202 to the long exposure frame 204). In some cases, the electronic device 100 can align features or feature points between the HDR frame 202 and a long exposure frame 204. For example, the electronic device 100 can determine a correspondence between features or feature points in the HDR frame 202 and a long exposure frame 204.

In some cases, the electronic device 100 can align pixels, features, and/or pixel regions between the HDR frame 202 and a long exposure frame 204. For example, the electronic device 100 can determine a correspondence between pixels, features, and/or pixel regions of the HDR frame 202 and a long exposure frame 204.

Based on the image alignment 206, the process 200 can generate an aligned long exposure frame 208. The aligned long exposure frame 208 can include the long exposure frame 204 aligned with the HDR frame 202, as previously described. The process 200 can then perform gradient estimation 210 based on the aligned long exposure frame 208 and the HDR frame 202, to generate a gradient estimation map 212. In some examples, the gradient estimation 210 can use block differences between the HDR frame 202 and the aligned long exposure frame 208 to determine a strength of image fusion for merging the HDR frame 202 and the aligned long exposure frame 208. For example, the gradient estimation 210 can determine which blocks within the HDR frame 202 and the aligned long exposure frame 208 are most similar.

In some examples, the gradient estimation 210 can include segmenting the HDR frame 202 and the aligned long exposure frame 208 into segmented blocks, and calculating the gradient estimation map 212 based on a comparison of the segmented blocks. In some cases, the gradient estimation 210 can determine differences (and/or values representing differences) between the segmented blocks of the HDR frame 202 and the segmented blocks of the aligned long exposure frame 208. In some cases, the gradient associated with a given block can be signal independent (e.g., can be independent of other blocks or block gradients).

In some cases, the gradient estimation 210 can compute differences between the HDR frame 202 and the aligned long exposure frame 208 (and/or portions thereof such as blocks, pixels, etc.) by evaluating a gradient model. In some examples, larger differences between blocks in the HDR frame 202 and the aligned long exposure frame 208 can indicate that the HDR frame 202 is noisy. Therefore, when fusing (e.g., merging) the HDR frame 202 and the aligned long exposure frame 208 as described below, when the differences between blocks in the HDR frame 202 and the aligned long exposure frame 208 are larger than a threshold, the merging can be biased toward the aligned long exposure frame 208. On the other hand, smaller differences between blocks in the HDR frame 202 and the aligned long exposure frame 208 can indicate that the HDR frame 202 is of good quality (e.g., in terms of texture, noise, brightness, color, and/or any other features). Therefore, when fusing (e.g., merging) the HDR frame 202 and the aligned long exposure frame 208 as described below, when the differences between blocks in the HDR frame 202 and the aligned long exposure frame 208 are smaller than a threshold, the merging can be biased toward the HDR frame 202.

The process 200 can then perform frequency domain fusion 214 using the gradient estimation map 212, the HDR frame 202, and the aligned long exposure frame 208. The process 200 can generate an output frame 216 based on the frequency domain fusion 214. Working in frequency domain to perform the image fusion can provide several advantages such as, for example, increased sparsity, which makes it easier to separate a signal from the gradient; robustness to misalignment; etc.

In some examples, to perform the frequency domain fusion 214, the electronic device 100 can calculate bias weights for respective blocks from the HDR frame 202 and the aligned long exposure frame 208, and apply the bias weights when merging blocks from the HDR frame 202 and the aligned long exposure frame 208. As previously explained, in some examples, when the difference between blocks in the HDR frame 202 and the aligned long exposure frame 208 are larger than a threshold, the bias weight associated with such blocks can bias the merging of such blocks toward the aligned long exposure frame 208. On the other hand, when the differences between blocks in the HDR frame 202 and the aligned long exposure frame 208 are smaller than a threshold, the bias weight associated with such blocks can bias the merging of such blocks toward the HDR frame 202.

In some cases, the frequency domain fusion 214 can include transforming blocks of the HDR frame 202 and the aligned long exposure frame 208 to a frequency domain, merging the blocks, and then transforming the blocks to the spatial domain (e.g., to the image domain).

In some examples, the fusion of the HDR frame 202 and the aligned long exposure frame 208 can be based on a pairwise frequency-domain temporal filter operating on the blocks of the input (e.g., the HDR frame 202 and the aligned long exposure frame 208). To quantify whether a given frequency coefficient matches the HDR frame 202, the electronic device 100 can use a weight (W) which controls the degree to which the aligned long exposure frame 208 is merged into the final result versus the HDR frame 202. In some examples, the weight (W) can be a given tuning parameter, per-band estimated parameters in the frequency domain, and/or gradient estimation.

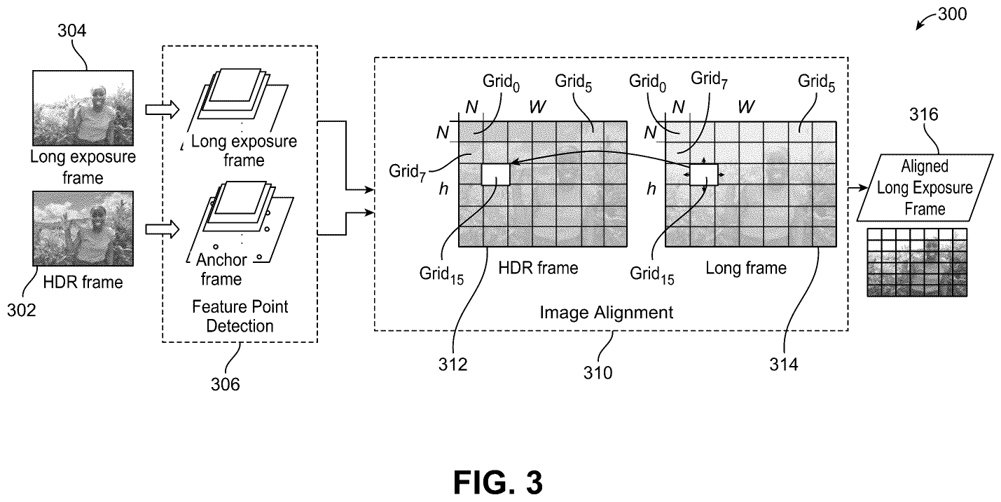

FIG. 3 is a diagram illustrating an example process 300 for image alignment, such as the image alignment 206 shown in FIG. 2. The process 300 can obtain an HDR frame 302 and perform feature point detection 306 to detect feature points in the HDR frame 302 and feature points in the long exposure frame 304. Based on the feature points detected on the HDR frame 302 and the long exposure frame 304, the process 300 can determine a dense correspondence between the long exposure frame 304 and the HDR frame 302 (e.g., between feature points, image blocks, and/or pixels of the long exposure frame 304 and the HDR frame 302). The dense correspondence between the long exposure frame 304 and the HDR frame 302 can be used to perform a global alignment between the long exposure frame 304 and the HDR frame 302. In some cases, the global alignment can include warping blocks of image pixels of the long exposure frame 304 based on the dense correspondence between the long exposure frame 304 and the HDR frame 302 (and/or global warping metrics determined based on the feature points on the HDR frame 302 and the long exposure frame 304).

In some examples, the detected feature points from the HDR frame 302 and the long exposure frame 304 can be used to calculate a homography matrix between the HDR frame 302 and the long exposure frame 304. The process 300 can use the homography matrix to perform global alignment between the HDR frame 302 and the long exposure frame 304. In some examples, the global alignment can use the homography matrix to warp blocks of image pixels of the long exposure frame 304 to better align the long exposure frame 304 with the HDR frame 302. In some cases, the warping of blocks of image pixels of the long exposure frame 304 can be at least partly based on global motion vectors estimated for the HDR frame 302 and the long exposure frame 304.

In some examples, the process can then perform a local image alignment 310. In the local image alignment 310, the process 300 can generate a grid 312 corresponding to the HDR frame 302 and a grid 314 corresponding to the long exposure frame 304. The local image alignment 310 can find local alignments between the grid 312 and the grid 314. For example, the local image alignment 310 can find local alignments between sub-grids in the grid 312 and the grid 314. In some examples, the local image alignment 310 can warp pixels in the grid 314 based on a correspondence with pixels in the grid 312, local alignment metrics, and/or local motion vectors associated with those pixels.

After the local image alignment 310, the process 300 can generate an aligned long exposure frame 316. The aligned long exposure frame 316 can reflect the global alignment between the HDR frame 302 and the long exposure frame 304 and the local image alignment 310.

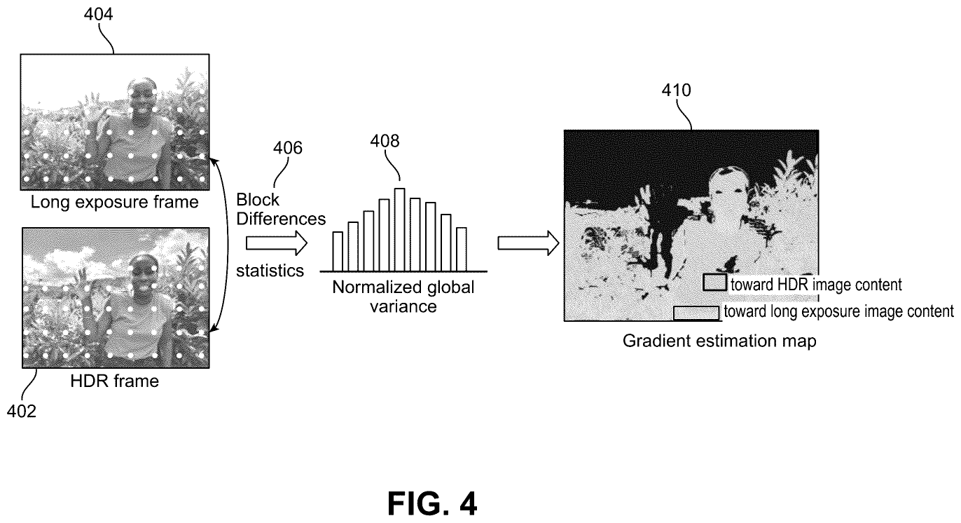

FIG. 4 is a diagram illustrating an example gradient estimation (e.g., gradient estimation 210 shown in FIG. 2) performed prior to an image fusion. In the gradient estimation, the electronic device 100 can calculate block differences 406 between blocks in the HDR frame 402 and blocks in the long exposure frame 404. In some examples, the block differences 406 can include differences in gradients determined for the HDR frame 402 and the long exposure frame 404.

The electronic device 100 can then generate a normalized global variance 408 for the block differences 406. In some examples, the electronic device 100 can the normalize block differences 406 to a range of values. Based on the normalized global variance 408, the electronic device 100 can generate a gradient estimation map 410. In some examples, the electronic device 100 can determine bias values for merging the HDR frame 402 and the long exposure frame 404. For example, the electronic device 100 can determine bias values based on the block differences 406 and/or the normalized global variance 408.

In some examples, when the difference between particular blocks in the HDR frame 402 and the long exposure frame 404 are larger than a threshold, the bias values can bias the merging of the HDR frame 402 and the long exposure frame 404 towards the long exposure frame 404. On the other hand, when the difference between particular blocks in the HDR frame 402 and the long exposure frame 404 are smaller than a threshold, the bias values can bias the merging of the HDR frame 402 and the long exposure frame 404 towards the HDR frame 402.

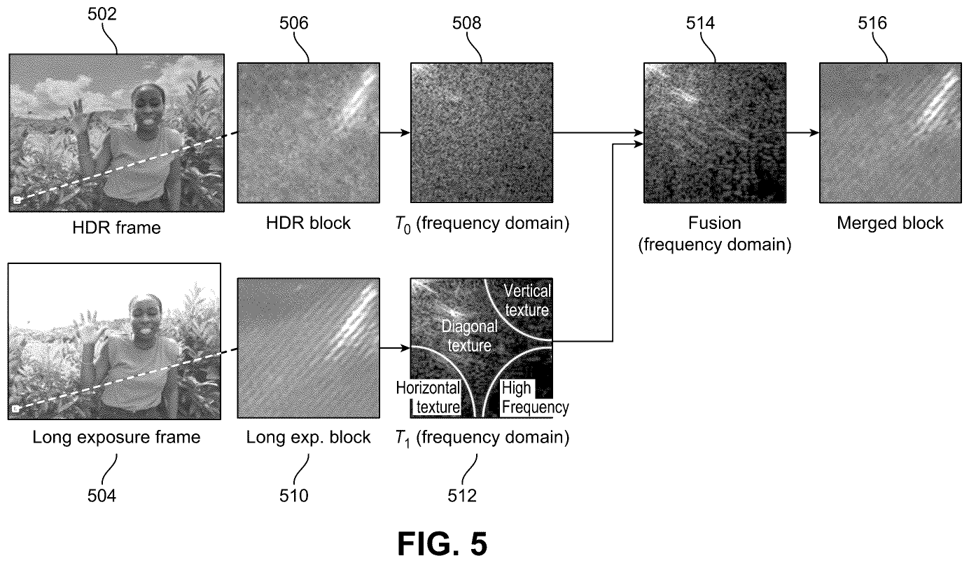

FIG. 5 is a diagram illustrating an example image fusion for merging an HDR frame and a long exposure frame. In this example, the electronic device 100 compares blocks (and/or associated pixels and/or feature points) of an HDR frame 502 and a long exposure frame 504 to identify block correspondences between the blocks in the HDR frame 502 and the blocks in the long exposure frame 504. For example, the electronic device 100 can determine a correspondence between the HDR block 506 in the HDR frame 502 and the long exposure frame block 510 in the long exposure frame 504. In some examples, the electronic device 100 can compare the blocks in the HDR frame 502 with the blocks in the long exposure frame 504 to determine matching or corresponding blocks based on the comparison (and/or block differences determined based on the comparison).

The electronic device 100 can transform pairs of corresponding blocks from the HDR frame 502 and the long exposure frame 504 into a frequency domain. For example, the electronic device 100 can transform HDR block 506 into block 508 in the frequency domain, and long exposure frame block 510 into block 512 in the frequency domain. In some cases, the electronic device 100 can transform pairs of corresponding blocks from the HDR frame 502 and the long exposure frame 504 into the frequency domain by applying a pairwise frequency-domain filter to the blocks.

The electronic device 100 can then fuse (e.g., merge) the block 508 in the frequency domain and the block 512 in the frequency domain into fused block 514 in the frequency domain. When fusing the block 508 and the block 512, the electronic device 100 can apply a bias weight to the block 512 associated with the long exposure frame 504. The bias weight can bias how much of the fused block 514 is influenced by the block 512 associate with the long exposure frame 504. For example, the bias weight can be reduced to reduce the influence/impact of the block 512 associated with the long exposure frame 504 on the fused block 514, or increase the bias weight to increase the influence of the block 512 on the fused block 514. In other words, the bias weight can drive how much of the block 512 associated with the long exposure frame 504 is reflected in the fused block 514 (e.g., a degree of similarity between the block 512 and the fused block 514).

In some cases, the image fusion can operate in the Fourier domain. In some examples, the electronic device 100 can merge the data for each spatial frequency independently. For example, in some cases, the electronic device 100 can perform a pairwise merge of block 508 and block 512 as follows:

(1−W)T₁+WT₀ Equation (1)

where W represents a weight, T₁ represents block 512, and T₀ represents block 508. In some cases, the weight (W) can be a given tuning parameter, per-band estimated parameters in the frequency domain, or a gradient estimation.

Once the fused block 514 is generated, the electronic device 100 can generate a merged block 516 based on the fused block 514. The merged block 516 can be an image block in the spatial/image domain. In some examples, to generate the merged block 516, the electronic device 100 can transform the fused block 514 to the spatial domain. The transformation to the spatial domain can result in the merged block 516 in the spatial domain. The merged block 516 can result in less noise (e.g., relative to the HDR frame 502), increased/better smoothness (e.g., relative to the HDR frame 502), increased texture (e.g., relative to the HDR frame 502), sharper details (e.g., relative to the HDR frame 502), etc.

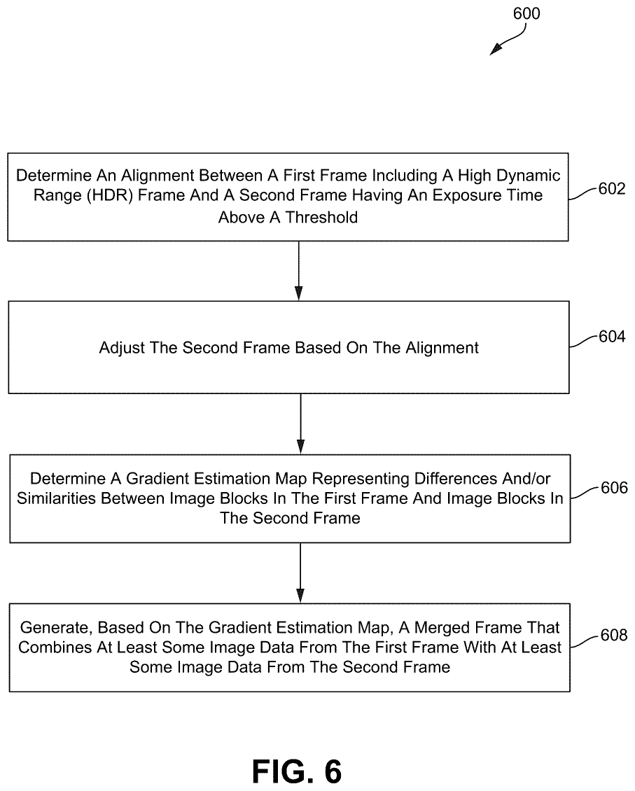

FIG. 6 is a flowchart illustrating an example process 600 for frequency domain edge enhancement of multi-exposure high dynamic range (HDR) images. At block 602, the process 600 can include determining an alignment between an HDR frame and a frame having an exposure time above a threshold. In some examples, the frame having the exposure time above the threshold can be a long exposure frame, such as long exposure frame 204. At block 604, the process 600 can include adjusting the frame based on the alignment.

In some examples, determining the alignment between the HDR frame and the frame can include detecting feature points in the HDR frame and features points in the frame. In some examples, adjusting the frame can include aligning the feature points in the frame with the feature points in the HDR frame.

In some examples, determining the alignment between the HDR frame and the frame can include determining a correspondence between the feature points in the frame and the feature points in the HDR frame.

In some cases, adjusting the frame can include warping image blocks of the frame based on a correspondence between the image blocks of the frame and associated image blocks of the HDR frame. In some cases, adjusting the frame can include warping image blocks of the frame based on motion vectors associated with the image blocks of the frame and the associated image blocks of the HDR frame. In some examples, the motion vectors can include a first set of motion vectors estimated for the image blocks of the frame and/or a second set of motion vectors estimated for grids of pixels of the frame.

In some aspects, the process 600 can include segmenting the frame into the grids of pixels and the HDR frame into additional grids of pixels; determining the second set of motion vectors for the grids of pixels based on motion between the grids of pixels and the additional grids of pixels; and warping the grids of pixels of the frame based on the second set of motion vectors.

At block 606, the process 600 can include determining a gradient estimation map (e.g., gradient estimation map 212) representing differences and/or similarities between image blocks in the HDR frame and image blocks in the frame. In some examples, determining the gradient estimation map can include determining values representing differences between image blocks in the frame and corresponding image blocks in the HDR frame; and determining the gradient estimation map based on the values representing the differences.

At block 608, the process 600 can include generating, based on the gradient estimation map, a merged frame (e.g., output frame 216) that includes a combination of at least some image data from the HDR frame and at least some image data from the frame.

In some examples, generating the merged frame can include determining, based on the gradient estimation map, bias weights for the image blocks in the frame; applying the bias weights to the image blocks in the frame to yield weighed image blocks of the frame; and combining the image blocks of the HDR frame with the weighed image blocks of the frame. In some aspects, the bias weights are based on a respective degree of differences between the image blocks in the frame and the image blocks in the HDR frame. In some examples, the bias weight for an image block in the frame increases as a difference between the image block in the frame and a corresponding image block in the HDR frame increases.

In some aspects, the process 600 can include determining a first set of image blocks of the HDR frame that corresponds to a second set of image blocks of the frame. In some cases, generating the merged frame can include transforming the first set of image blocks and the second set of image blocks to a frequency domain; merging the first set of image blocks in the frequency domain with the second set of image blocks in the frequency domain; and transforming merged image blocks in the frequency domain to a spatial domain. In some examples, the merged image blocks can include the first set of image blocks in the frequency domain merged with the second set of image blocks in the frequency domain.

In some examples, the process 200, the process 300, and/or the process 600 may be performed by one or more computing devices or apparatuses. In one illustrative example, the process 200, the process 300, and/or the process 600 can be performed by the electronic device 100 shown in FIG. 1. In some examples, the process 200, the process 300, and/or the process 600 can be performed by one or more computing devices with the computing device architecture 1200 shown in FIG. 7. In some cases, such a computing device or apparatus may include a processor, microprocessor, microcomputer, or other component of a device that is configured to carry out the steps of the process 200, the process 300, and/or the process 600. In some examples, such computing device or apparatus may include one or more sensors configured to capture image data and/or other sensor measurements. For example, the computing device can include a smartphone, a head-mounted display, a mobile device, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 200, the process 300, and the process 600 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 200, the process 300, and/or the process 600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 illustrates an example computing device architecture 700 of an example computing device which can implement various techniques described herein. For example, the computing device architecture 700 can implement at least some portions of the electronic device 100 shown in FIG. 1. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general-purpose processor and a hardware or software service stored in storage device 730 and configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device. In some instances, multimodal computing devices can enable a user to provide multiple types of input to communicate with the computing device architecture 700. The communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include software, code, firmware, etc., for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing image data, the apparatus comprising: a memory; and one or more processors coupled to the memory, the one or more processors being configured to: determine an alignment between a high dynamic range (HDR) frame and a frame having an exposure time above a threshold; adjust the frame based on the alignment; determine a gradient estimation map representing differences between image blocks in the HDR frame and image blocks in the frame; and generate, based on the gradient estimation map, a merged frame that includes a combination of at least some image data from the HDR frame and at least some image data from the frame.
Aspect 2. The apparatus of Aspect 1, wherein: to determine the alignment between the HDR frame and the frame, the one or more processors are configured to detect feature points in the HDR frame and features points in the frame; and to adjust the frame, the one or more processors are configured to align the feature points in the frame with the feature points in the HDR frame.
Aspect 3. The apparatus of Aspect 2, wherein, to determine the alignment between the HDR frame and the frame, the one or more processors are configured to determine a correspondence between the feature points in the frame and the feature points in the HDR frame.
Aspect 4. The apparatus of any of Aspects 1 to 3, wherein, to adjust the frame, the one or more processors are configured to: warp image blocks of the frame based on at least one of a correspondence between the image blocks of the frame and associated image blocks of the HDR frame, and motion vectors associated with the image blocks of the frame and the associated image blocks of the HDR frame.
Aspect 5. The apparatus of Aspect 4, wherein the motion vectors comprise at least one of a first set of motion vectors estimated for the image blocks of the frame and a second set of motion vectors estimated for grids of pixels of the frame.
Aspect 6. The apparatus of Aspect 5, wherein the one or more processors are configured to: segment the frame into the grids of pixels and the HDR frame into additional grids of pixels; determine the second set of motion vectors for the grids of pixels based on motion between the grids of pixels and the additional grids of pixels; and warp the grids of pixels of the frame based on the second set of motion vectors.
Aspect 7. The apparatus of any of Aspects 1 to 6, wherein, to generate the merged frame, the one or more processors are configured to: determine, based on the gradient estimation map, bias weights for the image blocks in the frame; apply the bias weights to the image blocks in the frame to yield weighed image blocks of the frame; and combine the image blocks of the HDR frame with the weighed image blocks of the frame.
Aspect 8. The apparatus of Aspect 7, wherein the bias weights are based on a respective degree of differences between the image blocks in the frame and the image blocks in the HDR frame.
Aspect 9. The apparatus of any of Aspects 7 or 8, wherein the bias weight for an image block in the frame increases as a difference between the image block in the frame and a corresponding image block in the HDR frame increases.
Aspect 10. The apparatus of any of Aspects 1 to 9, wherein, to determine the gradient estimation map, the one or more processors are configured to: determine values representing differences between image blocks in the frame and corresponding image blocks in the HDR frame; and determine the gradient estimation map based on the values representing the differences.
Aspect 11. The apparatus of any of Aspects 1 to 10, wherein the one or more processors are configured to determine a first set of image blocks of the HDR frame that corresponds to a second set of image blocks of the frame.
Aspect 12. The apparatus of Aspect 11, wherein, to generate the merged frame, the one or more processors are configured to: transform the first set of image blocks and the second set of image blocks to a frequency domain; merge the first set of image blocks in the frequency domain with the second set of image blocks in the frequency domain; and transform merged image blocks in the frequency domain to a spatial domain, the merged image blocks comprising the first set of image blocks in the frequency domain merged with the second set of image blocks in the frequency domain.
Aspect 13. The apparatus of any of Aspects 1 to 12, wherein the apparatus comprises a camera device.
Aspect 14. The apparatus of any of Aspects 1 to 12, wherein the apparatus comprises a mobile device.
Aspect 15. A method of processing image data, comprising: determining an alignment between a high dynamic range (HDR) frame and a frame having an exposure time above a threshold; adjusting the frame based on the alignment; determining a gradient estimation map representing differences between image blocks in the HDR frame and image blocks in the frame; and generating, based on the gradient estimation map, a merged frame that includes a combination of at least some image data from the HDR frame and at least some image data from the frame.
Aspect 16. The method of Aspect 15, wherein: determining the alignment between the HDR frame and the frame includes detecting feature points in the HDR frame and features points in the frame; and adjusting the frame includes aligning the feature points in the frame with the feature points in the HDR frame.
Aspect 17. The method of Aspect 16, wherein determining the alignment between the HDR frame and the frame includes determining a correspondence between the feature points in the frame and the feature points in the HDR frame.
Aspect 18. The method of any of Aspects 15 to 17, wherein adjusting the frame includes: warping image blocks of the frame based on at least one of a correspondence between the image blocks of the frame and associated image blocks of the HDR frame, and motion vectors associated with the image blocks of the frame and the associated image blocks of the HDR frame.
Aspect 19. The method of Aspect 18, wherein the motion vectors comprise at least one of a first set of motion vectors estimated for the image blocks of the frame and a second set of motion vectors estimated for grids of pixels of the frame.
Aspect 20. The method of Aspect 19, further comprising: segmenting the frame into the grids of pixels and the HDR frame into additional grids of pixels; determining the second set of motion vectors for the grids of pixels based on motion between the grids of pixels and the additional grids of pixels; and warping the grids of pixels of the frame based on the second set of motion vectors.
Aspect 21. The method of any of Aspects 15 to 20, wherein generating the merged frame includes: determining, based on the gradient estimation map, bias weights for the image blocks in the frame; applying the bias weights to the image blocks in the frame to yield weighed image blocks of the frame; and combining the image blocks of the HDR frame with the weighed image blocks of the frame.
Aspect 22. The method of Aspect 21, wherein the bias weights are based on a respective degree of differences between the image blocks in the frame and the image blocks in the HDR frame.
Aspect 23. The method of any of Aspects 21 or 22, wherein the bias weight for an image block in the frame increases as a difference between the image block in the frame and a corresponding image block in the HDR frame increases.
Aspect 24. The method of any of Aspects 15 to 23, wherein determining the gradient estimation map includes: determining values representing differences between image blocks in the frame and corresponding image blocks in the HDR frame; and determining the gradient estimation map based on the values representing the differences.
Aspect 25. The method of any of Aspects 15 to 24, further comprising determining a first set of image blocks of the HDR frame that corresponds to a second set of image blocks of the frame.
Aspect 26. The method of Aspect 25, wherein generating the merged frame includes: transforming the first set of image blocks and the second set of image blocks to a frequency domain; merging the first set of image blocks in the frequency domain with the second set of image blocks in the frequency domain; and transform merged image blocks in the frequency domain to a spatial domain, the merged image blocks comprising the first set of image blocks in the frequency domain merged with the second set of image blocks in the frequency domain.
Aspect 27: At least one non-transitory computer-readable medium containing instructions which, when executed by one or more processors, cause the one or more processors to perform operations according to any of Aspects 1 to 26.
Aspect 28: An apparatus comprising one or more means for performing operations according to any of Aspects 1 to 26.

What is claimed is:

1. An apparatus for processing image data, the apparatus comprising:
a memory; and
one or more processors coupled to the memory, the one or more processors being configured to:
determine an alignment between a high dynamic range (HDR) frame and a frame having an exposure time above a threshold;
adjust the frame based on the alignment;
determine a gradient estimation map representing differences between image blocks in the HDR frame and image blocks in the frame; and
generate, based on the gradient estimation map, a merged frame that includes a combination of at least some image data from the HDR frame and at least some image data from the frame.

2. The apparatus of claim 1, wherein:
to determine the alignment between the HDR frame and the frame, the one or more processors are configured to detect feature points in the HDR frame and features points in the frame; and
to adjust the frame, the one or more processors are configured to align the feature points in the frame with the feature points in the HDR frame.

3. The apparatus of claim 2, wherein, to determine the alignment between the HDR frame and the frame, the one or more processors are configured to determine a correspondence between the feature points in the frame and the feature points in the HDR frame.

4. The apparatus of claim 1, wherein, to adjust the frame, the one or more processors are configured to:
warp image blocks of the frame based on at least one of a correspondence between the image blocks of the frame and associated image blocks of the HDR frame, and motion vectors associated with the image blocks of the frame and the associated image blocks of the HDR frame.

5. The apparatus of claim 4, wherein the motion vectors comprise at least one of a first set of motion vectors estimated for the image blocks of the frame and a second set of motion vectors estimated for grids of pixels of the frame.

6. The apparatus of claim 5, wherein the one or more processors are configured to:
segment the frame into the grids of pixels and the HDR frame into additional grids of pixels;
determine the second set of motion vectors for the grids of pixels based on motion between the grids of pixels and the additional grids of pixels; and
warp the grids of pixels of the frame based on the second set of motion vectors.

7. The apparatus of claim 1, wherein, to generate the merged frame, the one or more processors are configured to:
determine, based on the gradient estimation map, bias weights for the image blocks in the frame;
apply the bias weights to the image blocks in the frame to yield weighed image blocks of the frame; and
combine the image blocks of the HDR frame with the weighed image blocks of the frame.

8. The apparatus of claim 7, wherein the bias weights are based on a respective degree of differences between the image blocks in the frame and the image blocks in the HDR frame.

9. The apparatus of claim 8, wherein the bias weight for an image block in the frame increases as a difference between the image block in the frame and a corresponding image block in the HDR frame increases.

10. The apparatus of claim 1, wherein, to determine the gradient estimation map, the one or more processors are configured to:
determine values representing differences between image blocks in the frame and corresponding image blocks in the HDR frame; and
determine the gradient estimation map based on the values representing the differences.

11. The apparatus of claim 1, wherein the one or more processors are configured to determine a first set of image blocks of the HDR frame that corresponds to a second set of image blocks of the frame.

12. The apparatus of claim 11, wherein, to generate the merged frame, the one or more processors are configured to:
transform the first set of image blocks and the second set of image blocks to a frequency domain;
merge the first set of image blocks in the frequency domain with the second set of image blocks in the frequency domain; and
transform merged image blocks in the frequency domain to a spatial domain, the merged image blocks comprising the first set of image blocks in the frequency domain merged with the second set of image blocks in the frequency domain.

13. The apparatus of claim 1, wherein the apparatus comprises a camera device.

14. The apparatus of claim 1, wherein the apparatus comprises a mobile device.

15. A method of processing image data, comprising:
determining an alignment between a high dynamic range (HDR) frame and a frame having an exposure time above a threshold;
adjusting the frame based on the alignment;
determining a gradient estimation map representing differences between image blocks in the HDR frame and image blocks in the frame; and
generating, based on the gradient estimation map, a merged frame that includes a combination of at least some image data from the HDR frame and at least some image data from the frame.

16. The method of claim 15, wherein:
determining the alignment between the HDR frame and the frame includes detecting feature points in the HDR frame and features points in the frame; and
adjusting the frame includes aligning the feature points in the frame with the feature points in the HDR frame.

17. The method of claim 16, wherein determining the alignment between the HDR frame and the frame includes determining a correspondence between the feature points in the frame and the feature points in the HDR frame.

18. The method of claim 15, wherein adjusting the frame includes:
warping image blocks of the frame based on at least one of a correspondence between the image blocks of the frame and associated image blocks of the HDR frame, and motion vectors associated with the image blocks of the frame and the associated image blocks of the HDR frame.

19. The method of claim 18, wherein the motion vectors comprise at least one of a first set of motion vectors estimated for the image blocks of the frame and a second set of motion vectors estimated for grids of pixels of the frame.

20. The method of claim 19, further comprising:
segmenting the frame into the grids of pixels and the HDR frame into additional grids of pixels;
determining the second set of motion vectors for the grids of pixels based on motion between the grids of pixels and the additional grids of pixels; and
warping the grids of pixels of the frame based on the second set of motion vectors.

21. The method of claim 15, wherein generating the merged frame includes:
determining, based on the gradient estimation map, bias weights for the image blocks in the frame;
applying the bias weights to the image blocks in the frame to yield weighed image blocks of the frame; and
combining the image blocks of the HDR frame with the weighed image blocks of the frame.

22. The method of claim 21, wherein the bias weights are based on a respective degree of differences between the image blocks in the frame and the image blocks in the HDR frame.

23. The method of claim 22, wherein the bias weight for an image block in the frame increases as a difference between the image block in the frame and a corresponding image block in the HDR frame increases.

24. The method of claim 15, wherein determining the gradient estimation map includes:
determining values representing differences between image blocks in the frame and corresponding image blocks in the HDR frame; and
determining the gradient estimation map based on the values representing the differences.

25. The method of claim 15, further comprising determining a first set of image blocks of the HDR frame that corresponds to a second set of image blocks of the frame.

26. The method of claim 25, wherein generating the merged frame includes:
transforming the first set of image blocks and the second set of image blocks to a frequency domain;
merging the first set of image blocks in the frequency domain with the second set of image blocks in the frequency domain; and
transforming merged image blocks in the frequency domain to a spatial domain, the merged image blocks comprising the first set of image blocks in the frequency domain merged with the second set of image blocks in the frequency domain.

27. A non-transitory computer-readable medium having stored thereon instructions that, when executed by one or more processors, cause the one or more processors to:
determine an alignment between a high dynamic range (HDR) frame and a frame having an exposure time above a threshold;
adjust the frame based on the alignment;
determine a gradient estimation map representing differences between image blocks in the HDR frame and image blocks in the frame; and
generate, based on the gradient estimation map, a merged frame that includes a combination of at least some image data from the HDR frame and at least some image data from the frame.

28. The non-transitory computer-readable medium of claim 27, wherein:
to determine the alignment between the HDR frame and the frame, the instructions that, when executed by the one or more processors, cause the one or more processors to detect feature points in the HDR frame and features points in the frame; and
to adjust the frame, the instructions that, when executed by the one or more processors, cause the one or more processors align the feature points in the frame with the feature points in the HDR frame.

29. The non-transitory computer-readable medium of claim 28, wherein, to determine the alignment between the HDR frame and the frame, the instructions that, when executed by the one or more processors, cause the one or more processors determine a correspondence between the feature points in the frame and the feature points in the HDR frame.

30. The non-transitory computer-readable medium of claim 27, wherein, to adjust the frame, the instructions that, when executed by the one or more processors, cause the one or more processors:
warp image blocks of the frame based on at least one of a correspondence between the image blocks of the frame and associated image blocks of the HDR frame, and motion vectors associated with the image blocks of the frame and the associated image blocks of the HDR frame.
